(19) United States
(12) Patent Application Publication
(10) Pub. No.: US 2006/0017197 A1
(43) Pub. Date: Jan. 26, 2006

(54) Coring of compression-molded phenolic

(76) Inventors: Donald J. Christensen, Phoenix, AZ (US); John Perek, Phoenix, AZ (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/895,503

(22) Filed: Jul. 20, 2004

(51) Int. Cl. B28B 7/30

(52) U.S. Cl. 264/313; 264/320

(57) ABSTRACT

A method is provided for fabricating a missile component, which may be a phenolic component, that includes the steps of covering at least a portion of a core insert with a composite material, compression molding the composite material on to the core insert to form the component, and destructively removing the core insert while the core insert is at least partially disposed within the component. The core insert may be thermally, mechanically, or chemically removed.

### FIELD OF THE INVENTION

The present invention relates to missiles and, more particularly, to valves that are used in the guidance of missiles.

### BACKGROUND OF THE INVENTION

Different types of missiles have been produced in response to varying defense needs. Some missiles are designed for tactical uses, while others are designed for strategic uses. Missiles typically have rocket motors that use hot propellant gases to thrust the missile forward. For missiles with guidance capabilities, valves may be employed that open or close to thereby redirect propellant gases to steer the missile in a desired direction.

Historically, missiles using thrust control valves have employed relatively simple geometric designs. The exhaust valves associated with these missile-types include component liners that define relatively simple flow paths (i.e., cylindrical, tubular, conical). Traditionally, component liners have been constructed of phenolic or rubber, which each can serve as an insulator to other exhaust valve components as well as an ablative that burns off when exposed to the propellant gases. Phenolic component liners may be made by compression-molding the phenolic around a solid insert shaped like the flow path. Alternatively, the component liner shape may be machined into a solid piece of phenolic.

Recently, the desire for smaller missiles having greater agility and the ability for longer flight missions has increased. As a result, missile designs have evolved to incorporate components having complex shapes that provide the desired precision guidance capabilities within these space constraints. These components may include flow paths having an L-shaped bend, an S-shape, or any one of a number of other complex shapes.

Although the aforementioned conventional methods have been adequate for the production of component liners having simple flow paths, they have not been as useful in the manufacture of component liners having complex flow paths. For example, in cases where the component is manufactured by a compression-molding process, the solid insert that is used may not be removable without inflicting damage to the component. Specifically, the solid insert may become trapped in the complex flow path. In the case where a machining process is employed, machining these complex flow paths into a solid piece of phenolic may be relatively difficult and time-consuming. Consequently, the costs of manufacturing these components may increase.

Thus, there is a need for a method of manufacturing that is useful for constructing missile components that have complex flow paths without damaging the component. It is also desirable to have a cost-efficient method for manufacturing missile components that may be implemented for mass production. The present invention addresses one or more of these needs.

### SUMMARY OF THE INVENTION

Methods are provided for fabricating a missile component. In one embodiment, and by way of example only, the method includes the step of covering at least a portion of a core insert with a composite material. The method also includes compression molding the composite material on to the core insert to form the component and destructively removing the core insert while the core insert is at least partially disposed within the component.

In another exemplary embodiment, a method for a missile component having a flow path is provided. The method includes covering at least a portion of a core insert having a shape substantially similar to the flow path with a phenolic composite, compression molding the phenolic composite on to the core insert to form the component and the flow path, and destructively removing the core insert while the core insert is at least partially disposed within the flow path.

Other independent features and advantages of the preferred method will become apparent from the following detailed description, taken in conjunction with the accompanying drawings which illustrate, by way of example, the principles of the invention.

### BRIEF DESCRIPTION OF THE DRAWINGS

FIG. 1 is a cross section of a portion of a propulsion section of a missle;

FIG. 2 is a flow chart illustrating a method of manufacturing a valve that may be implemented in the missile depicted in FIG. 1, according to one embodiment of the inventive method; and

FIG. 3 is an exemplary core insert that may be used in one embodiment of the inventive method.

### DETAILED DESCRIPTION OF A PREFERRED EMBODIMENT

The following detailed description of the invention is merely exemplary in nature and is not intended to limit the invention or the application and uses of the invention. Furthermore, there is no intention to be bound by any theory presented in the preceding background of the invention or the following detailed description of the invention. For illustration purposes only, the invention is described herein as being used to manufacture a thrust assembly component that may be employed on a missile, however, it will be understood that the method may be used to manufacture any component that may be exposed to extreme high temperatures, such as for tactical, strategic, or long range missiles, any type of thrust-propelled craft, such as spacecraft and torpedoes, or other engine components that are exposed to extreme high temperatures.

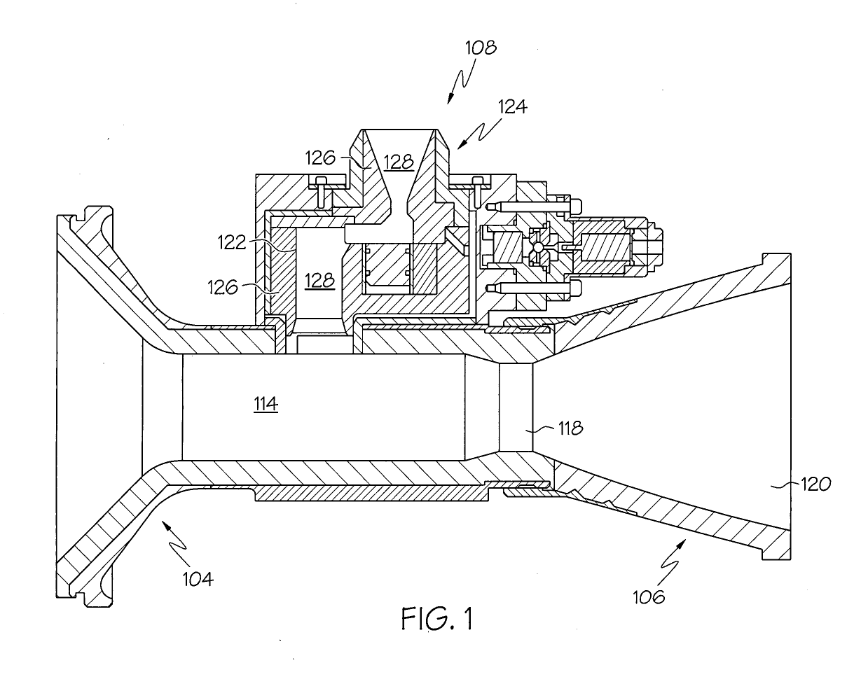

FIG. 1 is a cross section of a portion of a propulsion section of a missile. The propulsion section 100 includes a blast tube 104 coupled to a nozzle 106. The blast tube 104 further includes at least one thrust assembly 108 that is coupled thereto and in fluid communication with the blast tube 104.

The blast tube 104 is generally cylindrical in shape and includes a channel 114 therethrough that is configured to receive propellant gases from a non-illustrated motor, such as, for example, a solid rocket motor. The motor may include a fuel source that, when ignited, produces propellant gases and directs the gases into the blast tube 104. In the depicted embodiment, a portion of the propellant gases are directed through the blast tube 104 to the nozzle 106. As will be discussed more fully below, the remaining portion of the propellant gases are directed into the thrust assembly 108.

The nozzle 106 is coupled to the blast tube 104. In the depicted embodiment, the nozzle 106 is generally funnel-shaped and includes an inlet throat 118 in fluid communication with the blast tube 104 and an outlet 120 through which the propellant gases that enter the nozzle 106 may escape. When the propellant gases escape through the outlet 120, thrust is generated that propels the missile.

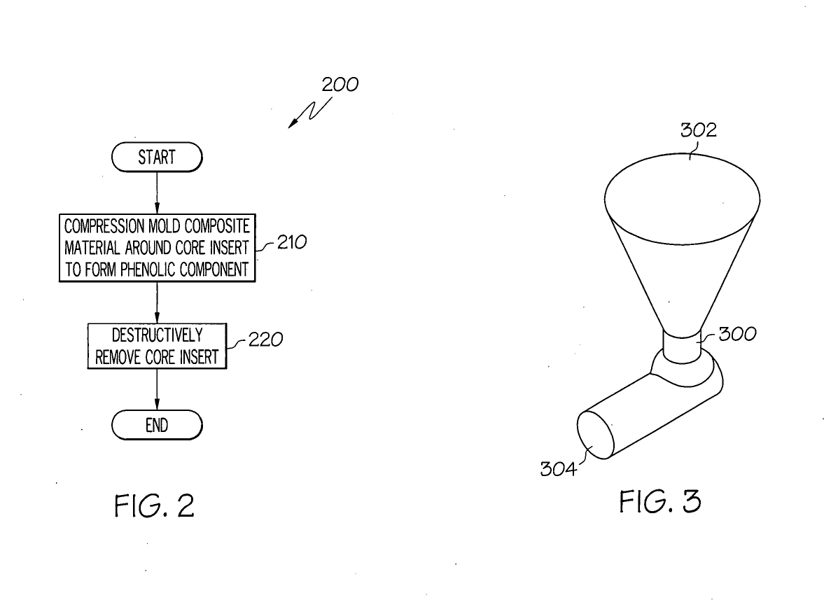

As was noted above, another portion of the propellant gases produced in the motor 102 is directed to the thrust assembly 108. The thrust assembly 108 includes at least a main inlet duct 122 and a valve nozzle 124. Both the main inlet duct 122 and valve nozzle 124 have a liner 126 which defines a flow passage 128. The flow passage 128 is shaped to divert a portion of the propellant gases from one direction to at least another. The flow passage 128 shape may also be configured to provide fine control of the pitch, yaw, roll, and thrust of an in—flight missile. In smaller missile configurations, the flow passage 128 may include any one of numerous shapes having any number of twists, turns, and bends. For instance, the flow passage 128 may be S-shaped, coil-shaped, or may include the two L-shaped bends and convergence/divergence, as shown in FIG. 1. Consequently, the thrust assembly components that make up the flow passage 128 are preferably constructed at least partially according to the inventive method. With reference to FIGS. 1 and 2, for ease of explanation, the exemplary method will be described as applied to the construction of a valve nozzle 124.

The overall process 200 is illustrated in FIG. 2, and will first be described generally. It should be understood that the parenthetical references in the following description correspond to the reference numerals associated with the flowchart blocks shown in FIG. 2. First, composite material is compression-molded around a core insert 300 (FIG. 3) to form a compression-molded phenolic component (210). Then, the core insert 300 is destructively removed by one of thermal, mechanical, or chemical methods, with minimal degradation to the phenolic component (220). These steps will now be described in further detail below.

Before discussing the process steps in more detail, it will be appreciated that, the core insert 300 shown in FIG. 3 is preferably a mold having a shape substantially identical to at least a portion of the flow passage 128 of the component to be constructed. Thus, the core insert 300 includes a first end 302 that will later become an inlet opening into the flow passage 128 and a second end 304 that becomes an outlet opening for fluids to exit the flow passage 128. The core insert-300 may be machined, molded, or formed into the shape of the flow passage 128. Because various material layers are deposited onto the core insert 300 during at least a portion of the manufacturing process, the core insert 300 is preferably made of a hard material capable of withstanding high temperatures and pressures encountered during molding. Additionally, the core insert 300 is preferably configured to be mechanically, chemically, or thermally removed from the interior of the component liner, the significance of which will be described in more detail below.

Returning now to a discussion of the process steps, as was noted above, the composite material is initially compression molded around the core insert 300 (210). Any conventional method for compression-molding may be employed. In one exemplary embodiment, the core insert 300 is placed into a container and substantially covered with the composite material. Examples of composite materials include, but are not limited to glass or carbon reinforced phenolic prepreg, or any other material that may be compression-molded into a phenolic component. The container and its contents are then heated to between about 325 and 350 degrees F. The heat consolidates and crosslinks the composite material to form an infusible thermoset polymer. Next, pressure is applied to the composite material, ranging from between about 2,000 to 6,000 psi, which causes the composite material to deform around the core insert 300. Consequently, a compression molded, cured, phenolic component is formed.

For reasons that will become more clearly understood below, it is preferable to form at least one opening in the phenolic component that extends from the outer periphery of the component to the core insert 300. Preferably, the opening is proximate the vicinity of the first end 302 or second end 304 of the core insert 300 and may be formed during the compression molding step (210). In one exemplary embodiment, the core insert 300 is placed in contact with the bottom of a container. As a result, the phenolic material is unable to flow between the core insert 300 and container, thus forming an opening in the phenolic component. In another exemplary embodiment, an opening is machined into the phenolic component after the component has been compression molded.

Turning back to FIG. 2 and the description of the method, the core insert 300 is destructively removed with minimal harm to the phenolic component (320). The core insert 300 may be destructively removed using any one of numerous methods, such as a thermal, mechanical, or chemical method. The destructive removal method depends, at least in part, upon the material from which the core insert 300 is constructed. Examples of selected ones of the thermal, mechanical, and chemical methods will now be described in more detail.

In one exemplary embodiment, the core insert 300 comprises a material that has a melting temperature that is higher than the processing temperature of the cured phenolic component. Heat sufficient to melt the core insert 300 is applied to the core insert 300, causing the insert 300 to liquefy and flow out of the component. In one embodiment, the core insert 300 is selectively heated using eletrical induction coils, thus melting the core insert 300 without subjecting the entire component to elevated temperatures. In another embodiment, the cured phenolic component and core insert 300 are placed into a batch furnace. The furnace is heated above the melting temperature of the insert 400 but below the thermal degradation temperature limit of the cured phenolic component, thereby causing the insert 400 to melt, but the component shape to remain intact. Examples of suitable materials having a melting point lower than the melting point of the phenolic component include, but are not limited to indium-lead solder.

In another exemplary embodiment, the core insert 300 comprises material capable of withstanding the temperatures and pressures of a compression molding process, but having less physical strength than the cured phenolic component. In one example, the material is susceptible to damage upon the application of sonic energy. Thus, when sufficient sonic energy is applied to the core insert 300, the molecular structure of the core insert 300 breaks down. As a result, the core insert 300 breaks apart, shatters into a plurality of pieces, or may pulverize into a powder. Suitable materials include clay, green ceramic, or sand.

In another example, the core insert 300 is constructed of material capable of being sand- or bead-blasted. These materials include but are not limited to, graphite, green ceramics, and sand with binder additives. In yet another example, the material is capable of breaking down upon the application of highly pressurized water. Materials having such properties include plaster or sand with binders.

In yet another exemplary embodiment, the core insert 300 is exposed to a chemical that reacts with and dissolves the insert 400 material. The phenolic component remains in tact while the core insert 300 erodes. Examples of suitable core insert 300 materials and chemicals that may erode the core insert 300 include but are not limited to acid or alkaline. In another example, the core insert 300 is constructed of a composite that includes sand, which dissolves when wetted.

The core insert 300 material is physically removed from the phenolic component. As noted above, the phenolic component preferably includes at least an opening that extends between its inner and outer peripheral surfaces. After the core insert 300 is liquefied, pulverized, dissolved, shattered into a plurality of pieces, or otherwise destroyed, the opening provides an outlet through which the insert 300 material exits. The insert 300 material may be shaken or gravitationally directed out of the opening.

While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

We claim:

1. A method for fabricating a component for use in a high temperature environment, the method comprising:
covering at least a portion of a core insert with a composite material;
compression molding the composite material on to the core insert to form the component; and
destructively removing the core insert while the core insert is at least partially disposed within the component.

2. The method of claim 1, wherein the core insert has a melting temperature and the component has a thermal degradation temperature and the core insert melting temperature is less than the component thermal degradation temperature.

3. The method of claim 2, wherein the step of destructively removing comprises:
melting at least a portion of the core insert to generate a melted core.

4. The method of claim 3, wherein the step of destructively removing further comprises:
removing the melted core from the component.

5. The method of claim 1, wherein the step of destructively removing comprises:
heating the core insert and component to a temperature above the melting temperature of the core insert to melt the core insert into a liquid.

6. The method of claim 5, wherein the step of destructively removing further comprises:
removing the melted core insert from the component.

7. The method of claim 2, wherein the component comprises phenolic and the core insert comprises indium-lead solder.

8. The method of claim 1, wherein the step of destructively removing comprises:
dissolving at least a portion of the core insert with a chemical.

9. The method of claim 8, wherein the step of destructively removing further comprises:
removing the dissolved core insert from the component.

10. The method of claim 8, wherein the component comprises phenolic and the core insert and chemical comprise one of an acid and an alkaline.

11. The method of claim 1, wherein the step of destructively removing comprises:
applying sonic energy to the core insert to cause the core insert to split into a plurality of core insert pieces.

12. The method of claim 3, wherein the step of destructively removing further comprises:
removing the plurality of core insert pieces from the component.

13. The method of claim 11, wherein the component comprises phenolic and the core insert comprises one of clay, green ceramic, and sand.

14. The method of claim 1, wherein the step of destructively removing comprises:
sand-blasting the core insert out of the component.

15. The method of claim 14, wherein the step of destructively removing further comprises:
removing the sand-blasted core insert from the component.

16. The method of claim 1, wherein the step of destructively removing comprises:
applying highly pressurized water to the core insert.

17. The method of clam 1, wherein the composite material comprises one of a glass reinforced phenolic prepreg and a carbon reinforced phenolic prepreg.

18. A method for a component having a flow path comprising:
covering at least a portion of a core insert having a shape substantially similar to the flow path with a phenolic composite;
compression molding the phenolic composite on to the core insert to form the component and the flow path; and
destructively removing the core insert while the core insert is at least partially disposed within the flow path.

19. The method of claim 18, wherein the core insert has a melting temperature and the component has a thermal degradation temperature and the core insert melting temperature is less than the component thermal degradation temperature.

20. The method of claim 19, wherein the step of destructively removing comprises:
melting at least a portion of the core insert to generate a melted core.

21. The method of claim 18, wherein the step of destructively removing comprises:
heating the core insert and component to a temperature above the melting temperature of the core insert to melt the core insert into a liquid.

22. The method of claim 21, wherein the core insert comprises indium-lead solder.

23. The method of claim 18, wherein the step of destructively removing comprises:
dissolving at least a portion of the core insert with a chemical.

24. The method of claim 24, wherein the core insert and chemical comprise one of an acid and an alkaline.

25. The method of claim 18, wherein the step of destructively removing comprises:
applying sonic energy to the core insert to cause the core insert to split into a plurality of core insert pieces.

26. The method of claim 25, wherein the core insert comprises one of clay, green ceramic, and sand.

27. The method of claim 18, wherein the step of destructively removing comprises:
sand-blasting the core insert out of the flow path.

28. The method of claim 18, wherein the step of destructively removing comprises:
applying highly pressurized water to the core insert.
